(19) United States
(12) Patent Application Publication
(10) Pub. No.: US 2006/0152479 A1
(43) Pub. Date: Jul. 13, 2006

(54) Intelligent text magnifying glass in camera in telephone and PDA

(76) Inventors: Michael Pierre Carlson, Austin, TX (US); Linda Arnold Lisle, Cedar Park, TX (US); Herman Rodriguez, Austin, TX (US)

Correspondence Address: IBM CORP (YA);C/O YEE & ASSOCIATES PC, P.O. BOX 802333, DALLAS, TX, 75380, US

(21) Appl. No.: 11/032,195

(22) Filed: Jan. 10, 2005

(51) Int. Cl. G09G 5/00

(52) U.S. Cl. 345/156

(57) ABSTRACT

A hand-held communication device, such as a mobile telephone or personal digital assistant, containing a camera is provided with the capability to distinguish printing from graphics in an image and to magnify and enhance the printing for display on the device. The device can thus aid a user in a situation needing visual enhancement, such as in a darkened restaurant.

### BACKGROUND OF THE INVENTION

1. Technical Field

This application relates generally to electronic enhancement of printed material for immediate viewing. More specifically, the application relates to using a handheld electronic device containing a camera to provide magnification and enhancement to written text, even if the text is embedded within non-text material.

2. Description of Related Art

Ever since the invention of the printing press, people have increasingly relied on the printed word for knowledge and ease of communications. With reliance on the printed word, however, persons who have difficulty focusing on close material, such as those with presbyopia, or who find themselves in low lighting conditions can find themselves unable to read what is before them.

A number of devices exist for aiding vision in reading. For those with severe problems, reading machines provide a closed-circuit television, with a lens that is generally focused on a flat surface where books, pictures, and other printed matter can be placed. The reading machines can provide up to 30× or 40× magnification of printed matter. On the other hand, they are at least the size of a small television and cost several thousand dollars, making them impractical for limited budgets and for traveling away from home. Reading glasses and even lighted magnifying glasses are a more practical answer for most situations, but the user has to make an effort to have these devices with them, and may not bother if the need is irregular. When the need does arise, the user often must rely on others for help in deciphering the written material. A better solution is desirable.

### SUMMARY OF THE INVENTION

Mobile telephones and personal digital assistants have become almost ubiquitous, with many of the newer devices combining the original capabilities with other devices, such as digital cameras. The addition of software that a) distinguishes print from graphics and b) magnifies and enhances the print can allow an electronic device containing a digital camera and display to provide magnification and enhancement of the printing, even when the words are embedded in or overlying graphics. At least some embodiments of the invention include the capability to recognize the language of the text and to provide a translation via online resources. At least some embodiments also include the ability to recognize different currencies and to provide conversions to another currency via online resources.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A depicts a mobile telephone with built-in camera in which an exemplary embodiment of the invention can be implemented.

FIG. 1B depicts a block diagram of the mobile telephone of FIG. 1A.

FIG. 2A depicts a personal digital assistant with add-on camera in which an exemplary embodiment of the invention can be implemented.

FIG. 2B depicts a block diagram of the personal digital assistant of FIG. 2A.

FIG. 3 depicts a flowchart that shows the basic operation of converting the input image to a displayed text.

FIG. 4 demonstrates the translation of foreign words and the conversion of foreign monies according to an exemplary embodiment of the invention.

### DETAILED DESCRIPTION OF THE PREFERRED EMBODIMENT

Hardware

Although the capability exists to add a digital camera into a large number of electronic devices, the most common devices to have these are mobile phones and personal digital assistants (PDAs). Wireless phones are fast becoming universal for anyone who can afford them, while PDAs are popular with those whose schedules are crowded. Both of these devices are small enough to be carried almost constantly by the user and hence are available at times when a stand-alone camera is not generally accessible.

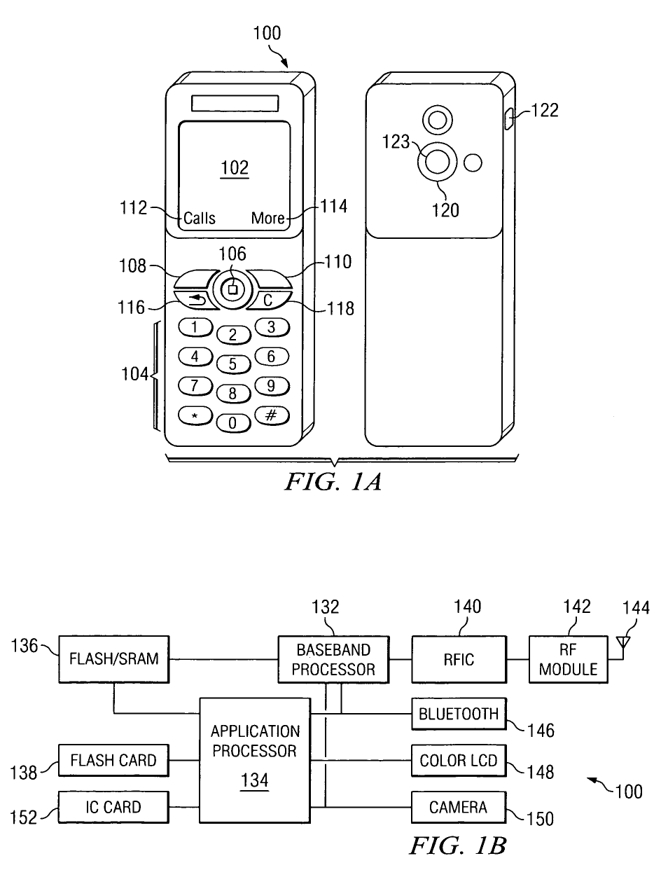

With reference now to FIG. 1A, an exemplary mobile telephone is disclosed that can use the inventive method, according to one embodiment of the invention. This figure demonstrates a model 610 available from Sony Ericsson. Mobile phone 100 will fit into a pocket, yet almost half of its front surface is taken up by screen 102, which is capable of displaying pictures. Additionally, there is a standard numeric keypad 104, a joystick 106, and four buttons placed around the joystick, including buttons 108, 110, which respectively provide the response shown by messages 112, 114, back button 116 and clear button 118. Looking at the reverse side of mobile phone 100, camera lens 120 is visible, as well as shutter button 122, which controls the electronic shutter 123 coupled with lens 120. Although not visible from the outside of the device, digital sensors pay an important role in the capturing of digital images. Digital camera sensors are used in combination with color filters to measure the brightness of each of the three primary colors of transmitted light: green, blue, and red. Depending on the type of sensor, the color filters are arranged either horizontally or vertically over the sensors. When the sensors are exposed to light, they capture the energy of the photons, which is then converted to an electrical charge. The camera processor then converts the captured electrical energy to pixel information so that it can save the image.

Turning to FIG. 1B, an exemplary block diagram of a camera phone is depicted in accordance with a preferred embodiment of the present invention. Camera phone 130 includes baseband processor 132, application processor 134, flash/static random access memory (SRAM) 136, flash card 138, radio frequency integrated circuit (RFIC) 140, radio frequency (RF) module 142, antenna 144, Bluetooth unit 146, color liquid crystal display (LCD) 148, camera 150, and IC card 152.

Baseband processor 132 provides for receiver and transmitter operations and is also referred to as a transceiver. In particular, baseband processor 132 handles all of audio, signal, and data processing needed to receive and send data using RF transmissions or Bluetooth transmissions. Application processor 134 provides the processing power for other functions within camera phone 130. For example, calculators, calendars, alarms, camera functions, and directories are provided through application processor 134. Flash/SRAM 136 is a storage device in which various instructions for providing the functions within camera phone 130 are located and provide upgrades. Flash card 138 is a storage device in which user data and applications may be stored. An example of flash card 138 is a secure digital card.

A pathway for the transmission of voice and other types of data is through RFIC 140. Additionally, short-range transmissions may be sent or received through Bluetooth unit 146. Bluetooth unit 146 conforms to Bluetooth wireless specification, which defines the link layer and application layer for product developers. Both of these transmissions are made through antenna 144 in this illustrative example.

Color LCD 148 provides a display for pictures and other data for camera phone 130. Camera 150, in this example, is a complementary metal oxide semiconductor (CMOS) camera that may be built into camera phone 130 or connected to camera phone 130 as a module, such as IC card 152. IC card 152 also may contain other application specific functions, such as a global positioning system (GPS) or other functions, such as a modem or additional memory.

Camera 150 forms the camera module of camera phone 130, while the other components form the digital phone module of camera phone 130 in these illustrative examples. Instructions or circuits are added to camera phone 150 to allow for control of the digital camera and allow the processing and display functions according to a preferred embodiment of the present invention.

Devices such as the disclosed mobile telephone/camera of FIG. 1A have a fairly short focal distance. When used with the inventive method, the distance between the device and target page is preferably in the range of 2-10 inches (50-250 millimeters); more preferably the distance is in the range of 2-3 inches (50-75 millimeters). This produces a clear image of the page that will allow the best quality of reproduction.

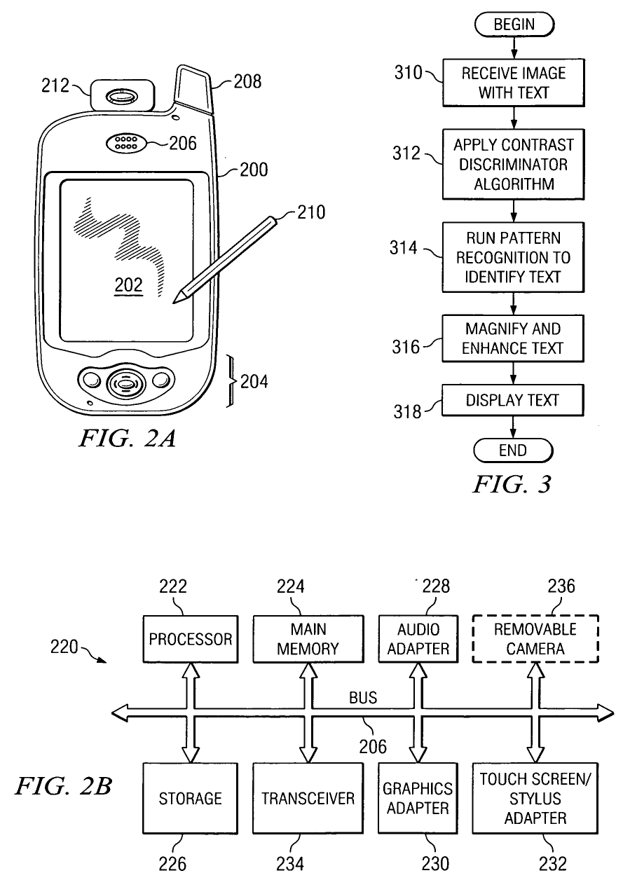

With reference now to FIG. 2A, a diagram of an electronic device in the form of a personal digital assistant (PDA) with add-on digital camera is depicted in accordance with a preferred embodiment of the present invention. PDA 200 includes a display screen 202 for presenting textual and graphical information. Display screen 202 may be a known display device, such as a liquid crystal display (LCD) device and may be used to present text, maps, calendar information, electronic mail messages, websites, and pictures, to name a few applications. Screen 202 may receive user input using an input device such as, for example, stylus 210.

PDA 200 may also include keypad 204, speaker 206, and antenna 208. Keypad 204 may be used to receive user input in addition to using screen 202. Speaker 206 provides a mechanism for audio output, such as presentation of an audio file. Antenna 208 provides a mechanism used in establishing a wireless communications link between PDA 200 and a network. Add-on camera 212 is shown inserted into the expansion slot of PDA 200. PDA 200 also preferably includes a graphical user interface that may be implemented by means of systems software residing in computer readable media in operation within PDA 200.

Turning now to FIG. 2B, a block diagram of a PDA, such as the PDA of FIG. 2A, is shown in which an embodiment of the present invention can be implemented. PDA 200 includes a bus 202 to which processor 204 and main memory 206 are connected. Display adapter 208, keypad adapter 210, storage 212, and audio adapter 214 also are connected to bus 202. As mentioned previously, in preferred embodiments, storage 212 is preferably expanded from typical PDAs, for example, by adding 1-2 GBytes by means of a flash card. Cradle link 216 provides a mechanism to connect PDA 200 to a cradle used in synchronizing data in PDA 200 with another data processing system. Further, display adapter 208 also includes a mechanism to receive user input from a stylus when a touch screen display is employed.

An operating system runs on processor 204 and is used to coordinate and provide control of various components within PDA 200. The operating system may be, for example, a commercially available operating system such as Windows Mobile, which is available from Microsoft Corporation, or Palm OS from PalmSource Inc. Instructions for the operating system and applications or programs are located on storage devices, such as storage 212, and may be loaded into main memory 206 for execution by processor 204. Camera 236 is shown by dotted lines to illustrate that it is removable. Once inserted into the expansion slot, camera 236 is attached to bus 206.

Those of ordinary skill in the art will appreciate that the hardware in FIGS. 1A and 2A may vary depending on the implementation. Other internal hardware or peripheral devices, such as flash ROM (or equivalent nonvolatile memory) or optical disk drives and the like, may be used in addition to or in place of the hardware depicted. Additionally, any electronic device with either a removable or built-in electronic camera and sufficient storage and processing space can be used with the inventive system and method.

Image Processing

The use of the inventive processing will now be discussed with reference to FIG. 3. This figure shows a flowchart of the action taken in an illustrative embodiment of the invention. The inventive process begins when a picture is taken and the processor receives an image (step 310). The first processing step is to run a contrast enhancement algorithm on the image to discriminate between foreground and background colors (step 312). Similar capabilities to adjust the amount of contrast between parts of an image are commonly found in programs dealing with digital photographs, such as Adobe Photoshop®. In the present setting, an image containing black text on a white background would require only a small discriminator value; red text on a white background would need a greater discriminator value; while yellow text on a white background would need an even greater discriminator value. Likewise, when the background is colored, patterned, or contains a photo or graphic, greater discrimination is needed. Preferably, the user can choose the aggressiveness of the discrimination settings. Alternatively, they can use an ‘Auto’ setting in which the program determines the optimal enhancement setting.

Once the discriminator program has isolated the foreground material, a pattern recognition algorithm is used to identify the text portion of the image (step 314). This program can be simple, to merely distinguish text from images or the program can be an optical character recognition program, which recognizes letters and words. Having discerned the text from other material on the page, it is then possible to provide magnification and enhancement of the text to make it easily readable by the user (step 316). In one embodiment, an image-rendering algorithm is used to magnify the text as needed, while providing smoothing of the enlarged text as magnification increases. In an alternate embodiment, once the text is recognized, it can be reformatted into a different font or the font size increased to aid readability. Finally, the enhanced and enlarged image is displayed on the screen (step 318). A scroll button or a combination of other buttons on the device can be used to allow the user to scroll down or across the resulting text.

Options

In a preferred embodiment of the invention, an options page allows the user to adjust the settings on the smart magnification process. For example, the user can set a desired magnification level or a desired font size for display. As previously mentioned, the aggressiveness of the discrimination algorithm can be set by the user or allowed to default to preset values. In at least one embodiment, default values for all options are set when the phone is initialized. This can include an automatic setting for the discrimination algorithm.

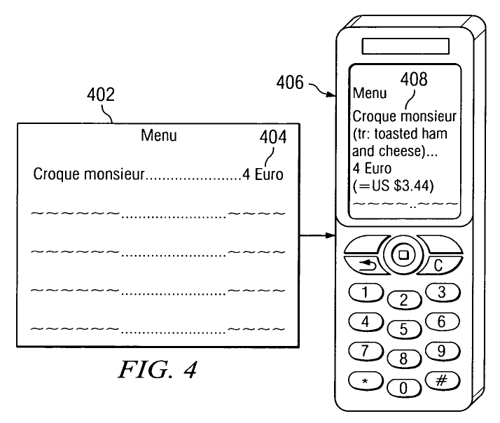

When a character recognition program is used, the text can be scanned to determine the language of the photographed document. Most mobile phones and PDAs contain a language setting, which the user can set to their preferred language. If text is encountered in the document that are not in the chosen language, the inventive program can optionally provide a translation of the foreign word(s). The translation can then be inserted into the text after the translated words or can be used to replace them. The processing and storage capabilities of the device are generally limited, but the translation itself does not need to be done by the device, since it can interface to outside sources having much greater capabilities. Alternatively, a software module can provide the translation service within the device. Likewise, when currency amounts are present in the photographed document, the inventive program can utilize outside sources, such as currency exchange rates, to provide a conversion into a currency most familiar to the user. Again, the default value for the desired currency can be taken from the users' preferred language; alternatively, the desired currency can be set in the options page for the inventive program. FIG. 4 shows a translation/conversion program in action. In this figure, a menu 402 has been photographed and converted to a different font for display. The menu 402 contains a line 404 for Croque monsieur, which costs 4 Euros. The phone on which the resulting display is shown is set for English and U.S. dollars. As a result, when the innovative program encounters this line, the resulting display shows the entry 408 with a translation of croquet monsieur as toasted ham and cheese and the price is converted from 4 Euros to $3.44 in U.S. dollars.

The options page can also provide the user a choice of the display they wish to receive. For example, in a darkened room, such as many restaurants in the evening, the user may find it easier to read white text on a black background, rather than the traditional black text on white background. Other variations can also be designed.

In at least one embodiment of the invention, a lens especially designed for the disclosed photographing of text can be used in addition to or instead of the original lens provided in the device.

The inventive device and method provide users with an ability to magnify and enhance text for reading, using only a device that many carry with them on a daily basis. This provides added value to the device and helps the user to cope in previously awkward situations.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A hand-held electronic device, comprising:
a lens and an array of sensors;
a processor, connected to receive the output of said array of sensors and to convert said output into an image composed of pixels;
a memory, coupled to receive said image;
a display, connected to display said image received in said memory; and
first instructions, executed by the processor, for enlarging and enhancing said image stored in said memory prior to displaying text contained in the image.

2. The electronic device of claim 1, wherein said electronic device is a mobile telephone.

3. The electronic device of claim 1, wherein said electronic device is a personal digital assistant.

4. The electronic device of claim 1, wherein said first instructions comprise applying a contrast discriminator function to the image.

5. The electronic device of claim 1, wherein said first instructions comprise applying a character recognition algorithm to the image.

6. The electronic device of claim 1, wherein said first instructions comprise applying a pattern recognition algorithm to the image.

7. The electronic device of claim 1, wherein said first instructions comprise magnifying a portion of the image that contains text to create magnified text.

8. The electronic device of claim 7, wherein said first instructions further comprise applying a smoothing algorithm to said magnified text.

9. The electronic device of claim 1, wherein said first instructions comprise formatting the text in a larger font.

10. The electronic device of claim 1, further comprising second instructions for recognizing a word in the image that is not in a desired language and using an online service to provide a translation of the word.

11. The electronic device of claim 1, further comprising second instructions for recognizing a word in the image that is not in a desired language and using a local service to provide a translation of the word.

12. The electronic device of claim 1, further comprising second instructions for recognizing a currency designation in the image that is not in a desired currency and using an online service to provide a conversion of the currency designation.

13. The electronic device of claim 1, further comprising second instructions for recognizing a currency designation in the image that is not in a desired currency and using a local service to provide a conversion of the currency designation.

14. A computer program product on a computer readable medium and designed for used on a hand-held electronic device containing a camera and a display, said computer program product comprising:
first instructions for capturing an image of the printed document with said camera in said hand-held electronic device;
second instructions for processing the image to form an enhanced image, wherein the text embedded in the printed document is magnified and enhanced in said enhanced image; and
third instructions for displaying said enhanced image on said display.

15. The computer program product of claim 14, wherein said second instructions comprise applying a contrast discriminator function to the image.

16. The computer program product of claim 14, wherein said second instructions comprise applying a pattern recognition algorithm to the image.

17. The computer program product of claim 14, wherein said second instructions comprise magnifying a portion of the image that contains text to create magnified text.

18. The computer program product of claim 14, wherein said second instructions comprise formatting the text in a larger font.

19. The computer program product of claim 14, further comprising fourth instructions for recognizing a word in the text that is not in a desired language and providing a translation of the word.

20. The computer program product of claim 14, further comprising fifth instructions for recognizing a currency designation in the text that is not in a desired currency and providing a conversion of the currency designation.
